(19) United States
(12) Patent Application Publication
(10) Pub. No.: US 2004/0151332 A1
(43) Pub. Date: Aug. 5, 2004

(54) Feedback management for hearing aid

(76) Inventors: Finn Danielsen, Hellerup (DK); Ulrik Skov, Hellerup (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/760,385

(22) Filed: Jan. 21, 2004

Related U.S. Application Data
(63) Continuation of application No. 09/807,000, filed on May 21, 2001, now abandoned.
Application No. 09/807,000 is a 371 of international application No. PCT/DK99/00536, filed on Oct. 7, 1999.

(30) Foreign Application Priority Data
Oct. 7, 1998 (DK) PA 1998 01274

(51) Int. Cl. H04R 25/00

(52) U.S. Cl. 381/318; 381/312

(57) ABSTRACT

The invention relates to a method of managing acoustic feedback in a hearing aid, characterised by using a multi (two or more) channel type of filter hereby splitting the frequency range up in two or more separate parts; determining the maximum allowable gain in at least one frequency range before feedback occurs; monitoring the volume control in such a way, that if the maximum allowable gain before feedback occurs is reached, the gain is manipulated for the offending frequency range. The determination of maximum allowable gain and the monitoring of the volume control is applied for several channels. The invention further relates to hearing aid implementing the method according to the method according to the invention.

### BACKGROUND OF THE INVENTION

The present invention relates to a method of managing acoustic feedback in hearing aids. Feedback is a problem, which occurs in a hearing aid when the acoustic output signal from the hearing aid propagates beside an ear mould or through a vent and consequently enter the hearing aid microphone as an acoustic input. The hereby closed acoustic loop will especially for frequencies above 1-2 kHz often cause the hearing aid to howl, which disables the function of the hearing aid.

During time several attempts have been made to avoid or to reduce the feedback problems of hearing aids. Previously known methods comprise the use of a high frequency cut-off filter to reduce the gain for the feedback management. This method can have the form of an isolated filter to be individually adjusted, but suffer from a drawback in that when the volume control of the hearing aid is turned down and hereby reduces the gain of the feedback frequencies, the filter is still in action reducing the high frequency gain. Another known method comprises a combination of the volume control and a high frequency cut-off filter meaning that when the volume control is turned up and hereby increases the gain of the hearing aid, the filter goes gradually into action and reduces the high frequency gain. The drawbacks of this scheme being that until now this could not be individually adjusted and secondly that the steepness of this filter was a modest 6 dB/octave.

The objective of the present invention is to provide a method for feedback management, which reduces the feedback problems without the previously mentioned drawbacks.

### SUMMARY OF THE INVENTION

The objective of the invention is achieved by a method, which is characterised by:

using a multi (two or more) channel type of filter hereby splitting the frequency range up in two or more separate parts

determining the maximum allowable gain in at least one frequency range before feedback occurs

monitoring the volume control in such a way, that if the maximum allowable gain before feedback occurs is reached or exceeded, the gain is manipulated for an offending frequency range.

By such a method the above mentioned drawbacks of the previously known methods are remedied and the feedback management may be adjusted individually for the actual user.

In a further embodiment the determining of the maximum gain before feedback occurs and the controlling the volume control is applied for several channels.

By using a multi channel type of filter it is possible by proper selection of the crossover frequencies to use the same type of filter for both feedback and adaption purposes. Using the same filter for both purposes reduces the size of the amplifier and to some extent also the cost of the amplifier.

A 1st or preferably higher order multi channel filter can be used for feedback management and adaptation purposes. This filter has shown to possess adequate properties for the purpose of the method according to the invention.

According to the invention the hearing aid comprises a housing containing a microphone, an amplifier in connection with the microphone, a receiver in connection with the amplifier, where the amplifier comprises a multi channel type of filter, a control system for monitoring the gain in at least one channel, and control means for controlling the volume control in the at least one channel.

In a further embodiment the determining of the maximum gain before feedback occurs and the controlling the volume control is applied for several channels.

In a preferred embodiment the multi channel filter is adapted for both feedback management and adaptation purposes.

The invention will be explained more detailed in the following with reference to the drawings.

### BRIEF DESCRIPTION OF THE DRAWINGS

FIG. 1-2 are drawings showing the function of a method according to the invention:

### DESCRIPTION OF THE PREFERRED EMBODIMENT

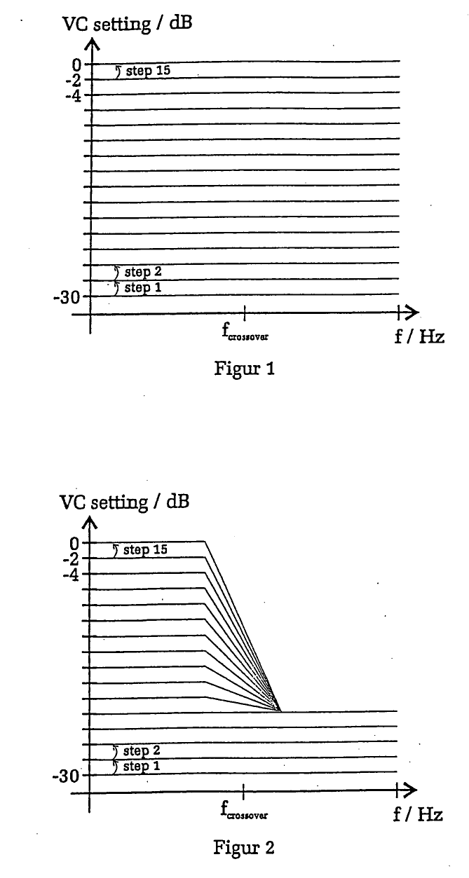

In the FIGS. 1 to 2 the multi channel filter has as an example been chosen to be a two channel type filter along with a suitable crossover frequency.

From FIG. 1 a situation appears where the feedback management has been disabled and the volume control functions in a conventional manner. The volume control comprise in this example 15 steps, each step defining a 2 dB increase or decrease of gain. All frequencies are subjected to the same increase or decrease of gain depending on the setting of the volume control.

From FIG. 2 a situation appears, where the maximum allowable gain in the high frequency channel before feedback occurs has been determined to volume control (VC) setting −12 dB. If the user exceeds this setting of the volume control, the control system takes over and for example keeps the gain in the high frequency channel constant and allows only an increase in gain for the low frequency channel.

The number of channels, step size, the number of steps etc. may in this connection be chosen different from the above example.

1. A method of managing acoustic feedback in a hearing aid, characterised by
using a multi (two or more) channel type of filter hereby splitting the frequency range up in two or more separate parts
determining the maximum allowable gain in at least one frequency range before feedback occurs
monitoring the volume control in such a way, that if the maximum allowable gain before feedback occurs is reached or exceeded, the gain is manipulated for an offending frequency range.

2. A method according to claim 1, characterized in that the determination of maximum allowable gain and the monotoring of the volume control is applied for several channels.

3. A method according to claim 1 or 2, characterised in that the multi channel filter is of 1. st order or higher.

4. A method according to claim 1, 2 or 3, characterised in that the multi channel filter is used for feedback management or for adaptation purposes or both.

5. A method according to any of the claims 1-4, characterized in that the gain in a manipulated frequency range is kept constant or only increased slightly.

6. A hearing aid comprising a housing containing a microphone, an amplifier in connection with the microphone, a receiver in connection with the amplifier, characterized in that the amplifier comprises a multi channel type of filter, a control system for monitoring the gain in at least one channel, and control means for controlling the volume control in the at least one channel.

7. A hearing aid according to claim 6, characterized in that the determining of the maximum gain before feedback occurs and the controlling the volume control is applied for several channels.

8. A hearing aid according to claim 6 or 7, characterized in that the multi channel filter is of 1. st order or higher order.

9. A hearing aid according to claim 6,7 or 8, characterized in that the multi channel filter is adapted for both feedback management and adaptation purposes.
